(19) United States
(12) Patent Application Publication
(10) Pub. No.: US 2005/0259270 A1
(43) Pub. Date: Nov. 24, 2005

(54) Fiberoptic fabry-perot optical processor

(75) Inventors: Michael D. Pocha, Livermore, CA (US); Charles F. McConaghy, Livermore, CA (US); Billy E. Wood, Livermore, CA (US); Glenn A. Meyer, Livermore, CA (US)

Correspondence Address: THE REGENTS OF THE UNIVERSITY OF CALIFORNIA, LAWRENCE LIVERMORE NATIONAL LABORATORY, PO BOX 808, L-703, LIVERMORE, CA, 94551-0808, US

(73) Assignee: The Regents of the University of California

(21) Appl. No.: 11/134,548

(22) Filed: May 20, 2005

Related U.S. Application Data
(60) Provisional application No. 60/573,215, filed on May 21, 2004.

(51) Int. Cl. G01N 21/25

(52) U.S. Cl. 356/519

(57) ABSTRACT

An optical signal processor having a monolithic prism supporting one or more channels, and constructed from a first glass block joined to a second glass block at a beam splitter interface. The monolithic prism has thin film beam splitters and filters (such as I and Q filters) either deposited directly on the prism or attached to it. The beam splitter interface, and the thin film beam splitters and filters are arranged relative to each other so that a portion of the return-ranging collimated encoded beam from an external optical sensor is reflected to all the filters. And detectors are connected over the filters to detect particular components of the collimated encoded beam which are passed through the respective filters.

### I. CLAIM OF PRIORITY IN PROVISIONAL APPLICATION

This application claims priority in provisional application No. 60/573215, filed on May 21, 2004, entitled “Fiberoptic Fabry-Perot Optical Processor” by Michael D. Pocha et al.

The United States Government has rights in this invention pursuant to Contract No. W-7405-ENG-48 between the United States Department of Energy and the University of California for the operation of Lawrence Livermore National Laboratory.

### II. FIELD OF THE INVENTION

The present invention relates to optical signal processors, and more particularly to a compact miniature fiber optic signal processor having a monolithic prism construction capable of supporting one or more channels in parallel and configured to implement the optic path of each channel entirely within the prism.

### III. BACKGROUND OF THE INVENTION

Fiber based Fabry-Perot sensors are widely used for measuring many physical/environmental parameters such as pressure, temperature, strain, acceleration, etc. They are known to have a number of beneficial properties over conventional electronic sensors, such as reducing/eliminating susceptibility to electromagnetic interference (EMI) and radio frequency interference (RFI), electrical isolation with no electrical current/power at the sensing area, insensitivity to radiation, remote readout, no wires, robust, wide temperature range, small size for high fidelity measurements, and high manufacturability and reproducibility. These optical sensors typically consist of small, low finesse cavities at the end of a fiber with two partially mirrored, low reflectivity surfaces (e.g. reflectivity 0.1-0.3) facing each other to form a gap therebetween. The gap width and changes thereof caused by a physical stimulus can be accurately measured to the precision of a few nanometers using straightforward broadband (white light) Fabry-Perot interferometric readout techniques. Background information on a commercially available fiber optic sensor based on a white light Fabry-Perot interferometric readout concept for measuring strain, temperature, etc., can be found in http://www.fiso.com. Such sensors are generally made by precisely positioning and attaching segments of optical fiber in tiny glass capillary tubes.

One particular technique developed to read out the change in cavity/gap dimensions is in phase and quadrature interferometry or “I/Q”, and is one of the most sensitive and accurate readout techniques for making this measurement. The I/Q technique measures a phase shift of the reflected interference fringes created by the Fabry-Perot cavity when illuminated by broad band (white) light through the fiber. Most I/Q systems rely on bandpass filters to make the coherence length sufficiently long to span the cavity gap of interest and produce amplitude modulated fringes for detection. The coherence length, Lc, is given by the approximation (λ²)/δλ^{fwhm} where λ is the wavelength and δλ^{fwhm} is the full width half maximum bandwidth of the filter. For example, a filter with a 10 nm bandwidth at 850 nm has a coherence length of 72 μm. The optimum bandwidth of the filter is based on a trade-off between being narrow enough to give the system sufficient coherence length to make fringes observable, yet broad enough to give reasonable optical signal strength for the detectors.

FIG. 1 shows a schematic diagram of a typical I/Q readout system known in the art. An LED broadband light source 11 (e.g. approximately 60 nm fwhm spectral bandwidth) is coupled into an optical fiber 12 and to a collimator 13 which creates a narrow freespace beam. This input beam is routed through a splitter 14 to another collimator 15 and to a Fabry-Perot optic sensor 17 via optic fiber 16. The encoded light from the Fabry-Perot cavity returns along the same optic fiber 16 and is directed by the splitter 14 upward. Because this is a broadband system the fringes are not visible. The beam is split again at beam splitter 18 and directed to two filters 19 and 23, which examine a narrow portion of the spectrum (e.g. about 10 nm wide) making fringes visible as an amplitude modulation. One of the filters 19 produces the in-phase signal, and the other filter 23 is tuned to a slightly different part of the spectrum (e.g. about 6-8 nm away) and produces a fringe pattern that is 90 degrees out of phase in quadrature, i.e. a quadrature signal. The signals are transmitted through respective coaxial connectors 21 and 25 and respective amplifiers 22 and 26, and to an analyzer 27 such as an oscilloscope, which may in turn be connected to a computer. The phase angle can be trigonometrically determined by the analyzer 27 from these two sinusoidal signals. As the Fabry-Perot sensor changes dimension due to a physical stimulus, the corresponding change in the phase angle allows the reconstruction of the temporal behavior of the phenomenon being measured.

While the readout techniques for fiber based Fabry-Perot sensors are straightforward, the instrumentation tends to be large. Commonly, standard rack mounted readout instrumentation is used. There is therefore still a need for miniaturization of this technique, and signal processing techniques generally, to address the size/dimensional requirements of various applications where the entire instrumentation system needs to fit into small spaces in physical assemblies under test. In particular, what is needed is a miniature single or multi-channel optical signal processor which may be used in conjunction with a wide variety of fiber optic systems, such as those based on Fabry-Perot optical sensors.

### IV. SUMMARY OF THE INVENTION

Generally, the present invention is a miniature optical signal processor having a monolithic prism supporting one or more channels and configured to minimize the optical path of a channel by implementing the optical path entirely within the prism. The monolithic prism may comprise either a single optically transparent block having an angled facet coated with a beam splitter, or two optically transparent blocks joined together at an angled beam splitter interface, which is preferably a 50:50 splitter. In either case, the angled beam splitter-coated facet/interface enables passage of an externally collimated input light beam, such as from an LED, into the prism and out to a sensor optically coupled to the prism, and is capable of internally reflecting a return-ranging collimated encoded beam returning from the sensor for downstream processing. Additional beam splitter(s) and mirror(s), or beam splitter(s) alone, are provided spaced and arranged on one or more of the prism surfaces to internally reflect the once-reflected encoded beam to one or more filters, preferably a pair of in phase (I) filter and a quadrature (Q) filter, (“I/Q filters”). By routing the collimated encoded beam to each of the I/Q filters in this manner, the respective I and Q components of the encoded beam may be separately derived. And detectors are affixed over the filters for detecting the I/Q components produced through the respective filters.

The incidence angle of the collimated encoded beam on the beam splitter interface is chosen to be about 60 degrees, which is preferably also the angle of the beam splitter interface to the horizontal. It is appreciated that the choice of about 60 degrees angle of incidence is a trade-off between sufficient deflection of the collimated encoded beam from the vertical to allow separation of the I-beam from the Q-beam vs. sufficient angle of incidence of the two beams to the top surface of the glass to prevent total internal reflection. At angles above about 65 degrees total internal reflection prevents the beam from passing through the filters for detection, and at 45 degrees the beams are completely overlapped. It is understood, therefore, that “about 60 degrees” prescribes a suitable range which is insufficient to cause total internal reflection, but large enough to provide suitable spacing between the two beam (and filters) such that they do not overlap.

The I-filter and the Q-filter are preferably thin film, multi-layer dielectric, bandpass elements. Thin film, multi-layer dielectric filters have the advantage that they can be deposited directly on the prism surface of the monolithic optical processor. It is appreciated, however, that the filters may also be formed first on respective optically transparent substrates which are then bonded either directly to a surface of the prism, or to an intermediate layer (e.g. beam splitter) already on the prism. In any case, the filter peak-wavelengths are selected to give approximately a Pi/4 phase shift at the wavelength of interest. The phase shift, Δλ is related to the cavity length, l, and wavelength λ by the equation:
nl=(λ²/8)Δλ.
For example, for λ=850 nm and l=15 μm, Δλ=6.02 nm. Since the cavity gap change is relatively short (5-10 μm). This effective phase change technique works with very small error.

While the detectors are not limited to any one type, they are preferably fabricated using commercially available silicon chips which have been flip-chip mounted on to a custom designed glass substrate wired for making the electrical connections. It is appreciated that the detectors may be independent units, or in the alternative, are part of a single detector material characterized by a plurality of detecting regions, such as pixels of a broad-area detector. With respect to the attachment of the detectors to the prism, or for that matter other layered components to the prism, various methods of affixing may be utilized including, for example, bonding discrete components together, or deposition-forming layers using fabrication methods known in the art. In the case of bonding, thin layers of transparent adhesive, such as for example UV-cured epoxy, may be used. The beam splitters and I/Q filters are preferably thin film, multi-layer dielectric bandpass elements which are deposition formed.

In any case, this monolithic configuration enables the present invention to be suitably dimensioned for miniaturized, space restrictive applications. For example, a prototype developed by the Applicants in research conducted for the Lawrence Livermore National Laboratory has been constructed having a single optical path of 1 cm long by 0.3 cm wide by 0.2-0.3 cm tall, which is a significant reduction in volume compared to optical paths of existing signal processors. And the monolithic structure also makes this optical path insensitive to vibration and shock. Thus the small size and ruggedness of the present invention makes it especially useful for field applications where the conditioner is placed in the same environment as the sensors. It is appreciated that while the monolithic optical signal processor of the present invention is particularly useful for systems using Fabry-Perot sensors, the signal processing techniques employed are general and applicable to a wide variety of fiberoptic systems.

One aspect of the present invention includes an I/Q optical signal processor comprising: a monolithic prism comprising an optically transparent block having a facet coated with a beam splitter (“beam splitter-coated facet”) for receiving a collimated input beam into the block, an output facet opposite the beam splitter-coated facet for exiting the collimated input beam out to an optical sensor and receiving a collimated encoded beam back from the optical sensor, and top and bottom surfaces extending between the beam splitter-coated facet and the output facet; an in-phase filter (“I-filter”) affixed over one of the top and bottom surfaces; a first detector affixed over the I-filter; a quadrature filter (“Q-filter”) affixed over one of the top and bottom surfaces at a different area than the I-filter; a second detector affixed over the Q-filter; wherein the beam splitter-coated facet defines a plane angled to reflect a portion of the collimated encoded beam as a first reflected beam to one of the I/Q filters (“upstream filter”), so that a corresponding in-phase or quadrature component of the collimated encoded beam is passed through the upstream filter and detected by a corresponding one of the first and second detectors; and means coated over at least one of the top and bottom surfaces for directing a portion of the first reflected beam to the other one of the I/Q filters (“downstream filter”), so that a corresponding in-phase or quadrature component of the collimated encoded beam is passed through the downstream filter and detected by a corresponding one of the first and second detectors.

Another aspect of the present invention includes an I/Q optical signal processor for use with a Fabry-Perot optic sensor comprising: a monolithic prism comprising an optically transparent first block joined to an optically transparent second block at a beam splitter interface to form first and second ends on opposite sides of said beam splitter interface with top and bottom surfaces extending between the first and second ends, said first end having an input facet through which at least one collimated input beam may enter the prism, and said second end having an output facet through which the collimated input beam may exit out to a Fabry-Perot optical sensor and a collimated encoded beam from the Fabry-Perot optical sensor may re-enter the prism; an in-phase filter (I-filter) affixed over one of the top and bottom surfaces on the same side of the beam splitter interface as the output facet; a first detector affixed over the I-filter; a quadrature filter (Q-filter) affixed over one of the top and bottom surfaces on the same side of the beam splitter interface as the output facet and at a different area than the I-filter; a second detector affixed over the Q-filter; wherein the beam splitter interface defines a plane angled to reflect a portion of the collimated encoded beam as a first reflected beam to one of the I/Q filters (upstream filter), so that a corresponding in-phase or quadrature component of the collimated encoded beam is passed through the upstream filter and detected by a corresponding one of the first and second detectors; and means coated over at least one of the top and bottom surfaces for directing a portion of the first reflected beam to the other one of the I/Q filters (downstream filter), so that a corresponding in-phase or quadrature component of the collimated encoded beam is passed through the downstream filter and detected by a corresponding one of the first and second detectors.

And another aspect of the present invention includes a monolithic optical signal processor comprising: a monolithic prism having a plurality of facets; a first filter affixed over one of said facets; a first detector affixed over the first filter; a second filter affixed over one of said side facets at a different location from the first filter; a second detector affixed over the second filter; and facet-covering means for directing a collimated encoded light beam to both the first filter and the second filter from within the prism so that a first component of the collimated encoded light beam is passed through the first filter and detected by the first detector, and a second component of the collimated encoded light beam is passed through the second filter and detected by the second detector.

### V. BRIEF DESCRIPTION OF THE DRAWINGS

The accompanying drawings, which are incorporated into and form a part of the disclosure, are as follows:

FIG. 1 is schematic view of an I/Q optical signal processing system known in the art using a Fabry-Perot optical sensor.

FIG. 2 is an exploded cross-sectional view of a first exemplary embodiment of the monolithic optical signal processor of the present invention.

FIG. 3 is a side cross-sectional view of the first exemplary embodiment of FIG. 2 illustrating the optical beam path of a single representative channel.

FIG. 4 is a cross-sectional side view of a second preferred embodiment of the present invention similar to FIG. 3, but having one additional pair of I/Q filters, with all the filters on the same side (i.e. top surface) of the monolithic prism.

FIG. 5 is a cross-sectional side view of a third preferred embodiment of the present invention, having two filters on opposite sides (i.e. top and bottom surfaces) of the monolithic prism.

FIG. 6 is a cross-sectional side view of a fourth preferred embodiment of the present invention similar to FIG. 5, but having one additional pair of I/Q filters on opposite sides of the monolithic prism.

FIG. 7 is a cross-sectional side view of a preferred embodiment of the present invention where the monolithic prism comprises a single optically transparent block.

FIG. 8 is a perspective view of a multi-channel embodiment of the present invention.

### VI. DETAILED DESCRIPTION OF THE PREFERRED EMBODIMENTS

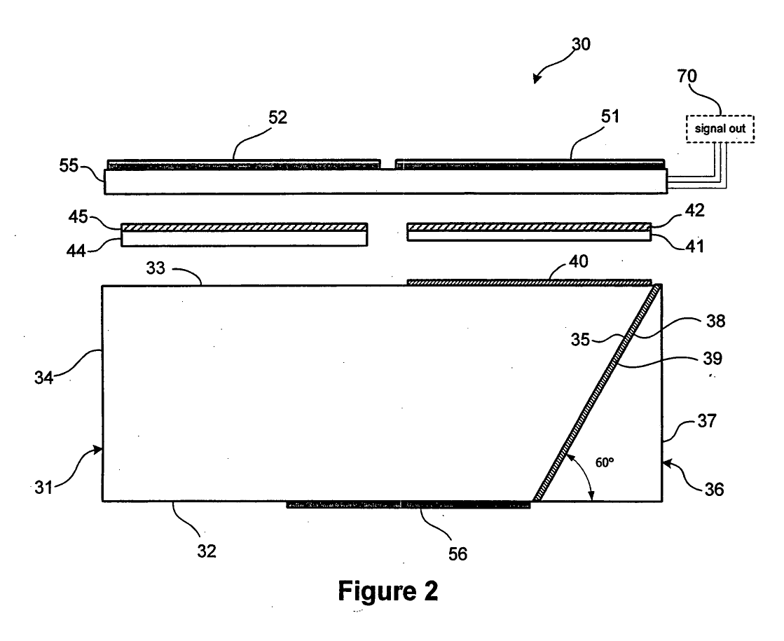

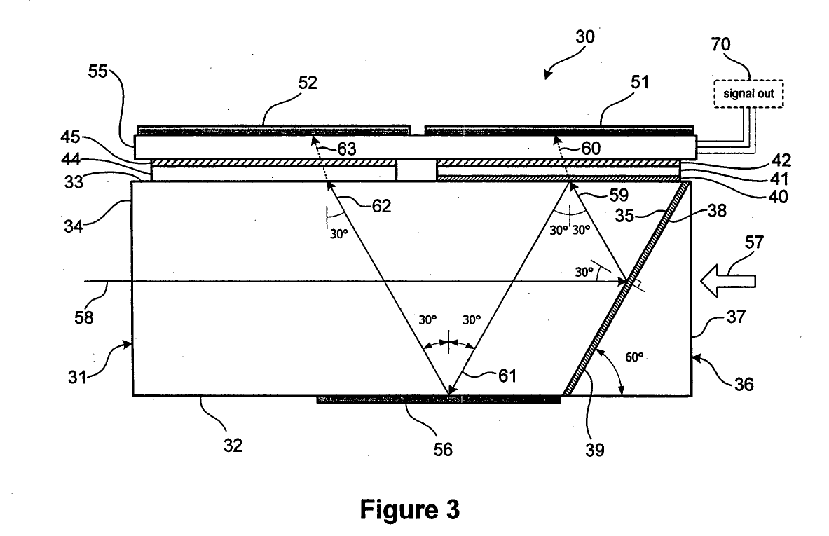

Turning now to the drawings, FIGS. 2 and 3 show an exploded cross-sectional side view of a first preferred embodiment of the monolithic optical signal processor of the present invention, generally indicated at reference character 30, and illustrating the layered arrangement of components which enables the short optic path of the present invention. The core component of the processor 30 is a monolithic, rigid body prism comprising a first optically transparent block 36 joined (e.g. cemented or otherwise bonded) to a second optically transparent block 31 at a beam splitter interface 39. In particular, the beam splitter interface 39 is a beam splitter layer coated between an angled facet 38 of the first block 36 and an angled facet 35 of the second block 31, and is preferably an approximately 50:50 splitter. And the optically transparent blocks 31 and 36 are preferably made of a glass material, such as for example fused silica glass, but it is appreciated any suitably transparent optical material may be used.

The prism also has an input facet 37 at one end, and an output facet 34 at an opposite end, with the input and output facets on opposite sides of the beam splitter interface 39. Both the input and output facets are preferably shown parallel to each other and orthogonal to a collimated input beam 57 as well as the collimated encoded beam 58 (FIG. 3). The prism also has a bottom surface 32 and a top surface 33 extending between the input facet and the output facet. It is appreciated that while the top and bottom surfaces 33, 32 are each shown as a single continuous facet, each of the surfaces may comprise one or more facets which together extend across to connect the input and output facets. A mirror 56 is shown formed on the bottom surface 32 of the prism, while a second beam splitter 40 is shown formed on the top surface 33. Both the mirror 56 and the second beam splitter 40 are adjacent the beam splitter interface 39 and located on the same side of the beam splitter interface as the output facet 34, i.e. on the second optically transparent block 31. Furthermore, the beam splitter of the beam splitter interface 39 and the second beam splitter 40 are each preferably a multilayer dielectric stack formed using techniques known in the relevant art, such as for example deposition forming.

An I-filter 42 is shown affixed over the second beam splitter 40, and a Q-filter 45 is shown affixed directly over the top surface 33. As best shown in FIG. 2, the I/Q filters 42, 44 are each part of a layered construction formed on respective optically transparent substrates 41, 44. In the alternative, they may be direct deposited. In any case, detectors 51 and 52 are then affixed over the respective filters 42 and 44. In particular, the detectors 51 and 52 are shown flip chip mounted to an optically transparent substrate 45, such as a sapphire substrate, having electrical connections for transmitting a detection signal out for analysis, indicated at 70. While both detectors 51 and 52 are shown mounted on the single substrate 55, it is appreciated that detectors may be alternatively mounted to separate substrates to form independent detector modules (not shown).

FIG. 3 shows the shortened optic path of a representative single channel. An externally collimated input beam 57 (external collimator not shown), such as from an LED, is first passed through the input facet 37 and into the prism. The input beam 57 then passes through the angled beam splitter interface 39, and out the output facet 34 where it is transmitted to an optically coupled external sensor (not shown), which is preferably a Fabry-Perot sensor. A return-ranging, externally collimated encoded beam 58 (second external collimator not shown) returns back from the external optical sensor to incidence the beam splitter interface 39 at about 60 degrees angle of incidence. The encoded beam 58 reflects off the angled beam splitter 39 as a first reflected beam 59 upward to the second beam splitter 40. A portion of the first reflected beam 59, i.e. the in phase (I) component 60, is passed through the I-filter 42 to the corresponding detector 51. And another portion of the first reflected beam 59 is again reflected as second reflected beam 61 to an opposite side of the prism, and in particular to the mirror 56 alignably positioned to be incidenced by the second reflected beam 61. At the mirror, the second reflected beam 61 is fully reflected back to the top surface 33 as a third reflected beam 62 where a quadrature (Q) component 63 of the beam is passed through the Q-filter 45 to the corresponding detector 52.

While the I-filter and Q-filter are arranged so that the I-filter is incidenced first and the Q-filter is incidenced second, it is appreciated that the order may be reversed. Thus either one of the I/Q filters may be assigned as the “upstream filter” with the remaining filter assigned as the “downstream filter.” Generally, the beam splitter interface 39 reflects the encoded beam to the upstream filter where it may be further reflected to a downstream filter. Thus, where the upstream and downstream filters are located on the same side of the prism as each other, e.g. on the top surface 33 as in FIGS. 2 and 3, the mirror 56 serves to reflect a portion of the encoded beam from one filter to the other.

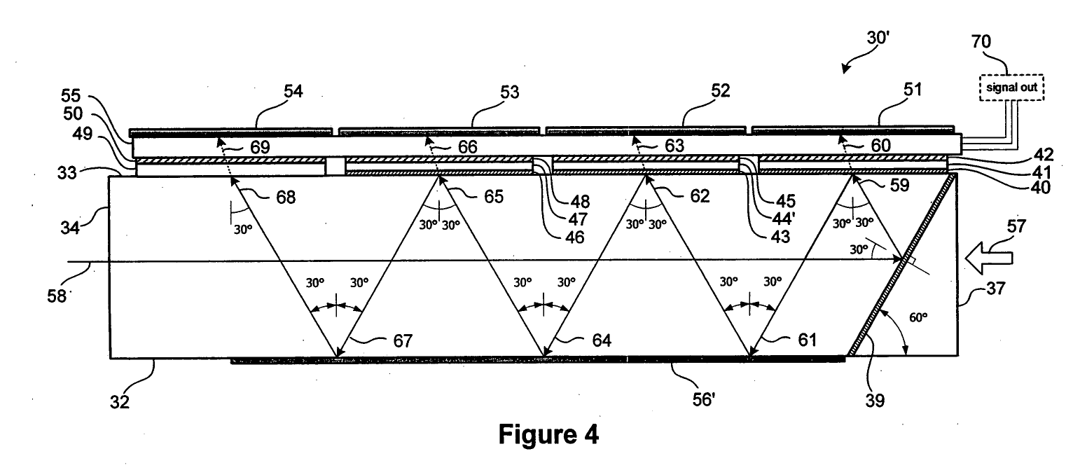

FIG. 4 shows a second preferred embodiment of the present invention similar to FIG. 3, but having one additional pair of I/Q filters 48 and 50 on the same top surface 33 as the first pair of I/Q filters 42 and 45. It is again appreciated that the order of the filters in the optic path is not critical. Each of the additional filters 48 and 50 have a corresponding detector 53 and 54 mounted on the substrate 54 shown extended to accommodate the additional detectors. The upstream one of the additional filters, i.e. 48, is shown having an associated optically transparent substrate 47 bonded to a beam splitter 46 formed on the top surface 33. And the downstream one of the additional filters, i.e. 50, is shown having an associated optically transparent substrate 49 directly connected to the top surface 33, as being the last filter in the series. And the Q-filter 45 of the upstream pair now has a beam splitter 43 layered between the filter substrate 44′ and the top surface 33, which enable further transmission by internal reflection of the encoded beam 58. The optic path is thereby increased by reflecting a fourth reflected beam 64 from the beam splitter 43 to the mirror 56′ which has an increased length than the mirror 56 of FIG. 3. The fourth reflected beam 64 is then fully reflected as a fifth reflected beam 65 to beam splitter 46 where a corresponding I or Q component is filtered and passed through the filter 48 and detected. A portion of the fifth reflected beam 65 is reflected as a sixth reflected beam 67 back to the mirror 56′ where it is again fully reflected a seventh reflected beam 69 to the final filter 50 where a corresponding component of the beam is filtered and passed through to be detected by detector 54.

The additional pairs of I/Q filters and detectors enable the monolithic optical signal processor 30′ to operate based on absolute measurements and not relative measurements. It is appreciated that relative measurements using a fringe, by fringe measurement technique, gives the change in gap from a starting point, without providing any information of the absolute gap at the starting point. Typically the relative measurement, allows use of a narrower band, but brighter source such as an LED. Though narrower, this is still a white-light technique with its advantages of relatively stable fringes independent of light source wavelength variations. However, by providing two pairs of I/Q filters/detectors, two LED's at different wavelengths may be used for absolute measurements. This is accomplished by using one I/Q filter pair to detect phase change at a first wavelength, and using the other I/Q filter pair to detect phase change at a second wavelength, so that the centroid of the fringe pattern may be located to thereby obtain a measurement of the gap width. And additional LED's at more different wavelengths and pairs of I/Q filters can further be used improve signal to noise ratios.

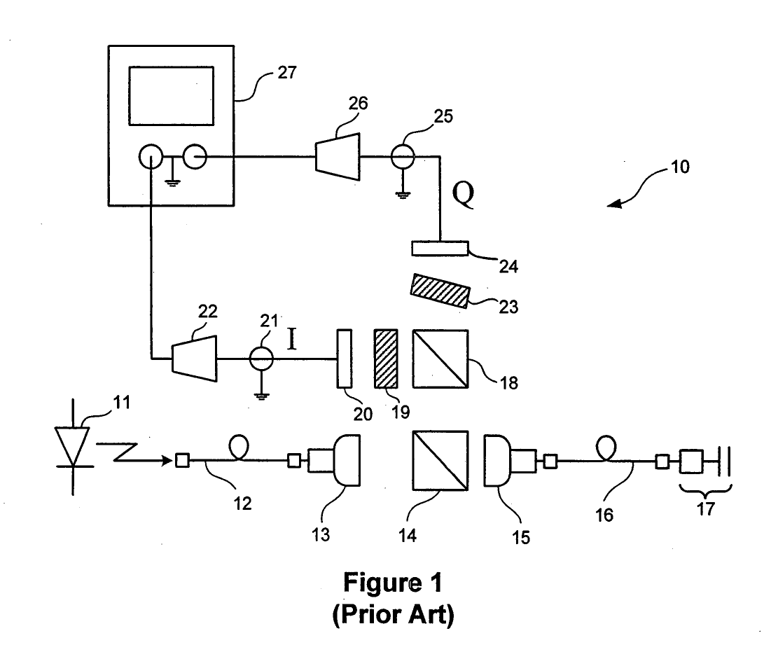

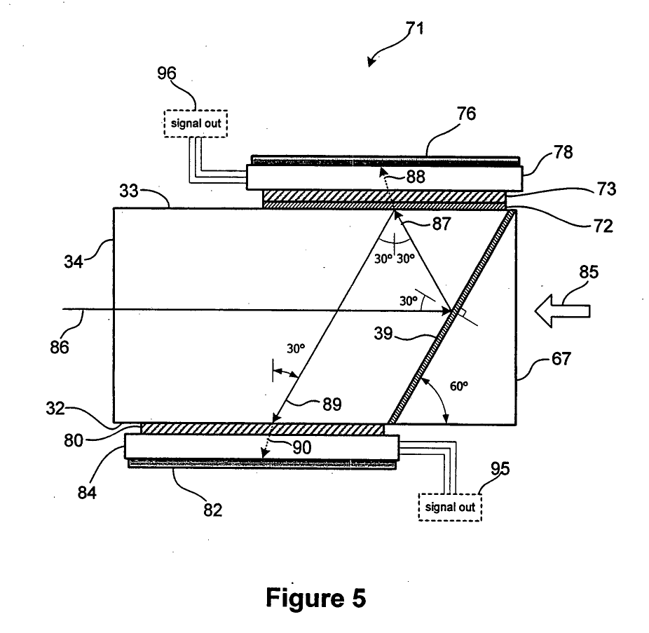

FIG. 5 shows a third preferred embodiment of the monolithic optical processor of the present invention, generally indicated at reference character 71, having a similar monolithic prism construction as discussed for FIGS. 1-3. Here, however, the upstream filter 73 and the downstream filter 80 are located on opposite sides of the prism. In particular, a beam splitter 72 is coated on the top surface 33 of the prism, and the upstream filter 73 is shown directly contacting the splitter 72 (by direct deposition or bonding). A detector 76, including optically transparent substrate 78 is affixed, e.g. by bonding, over the upstream filter. Similarly, the downstream filter 80 is shown directly contacting the bottom surface 32, with a corresponding detector 82 bonded thereto via optically transparent substrate 84. As before, the optic path is characterized by entry of a collimated input beam 85, which is reflected back from an external sensor (not shown) as a collimated encoded beam 86 to incident the beam splitter interface 39. A portion of the encoded beam 86 is reflected as a first reflected beam 87 to the beam splitter 72 where a corresponding I or Q component is passed through the filter 73 and detected at 76. A portion of the first reflected beam 87 is reflected by the beam splitter 72 directly towards the downstream filter 80, where a corresponding one of the I or Q components is passed through the filter 80 and detected at 82. Since the second beam splitter 72 reflects the second reflected beam 89 directly to the downstream filter 80, a mirror is not necessary. The detected signals are then transmitted out to an analyzer as indicated at 95 and 96.

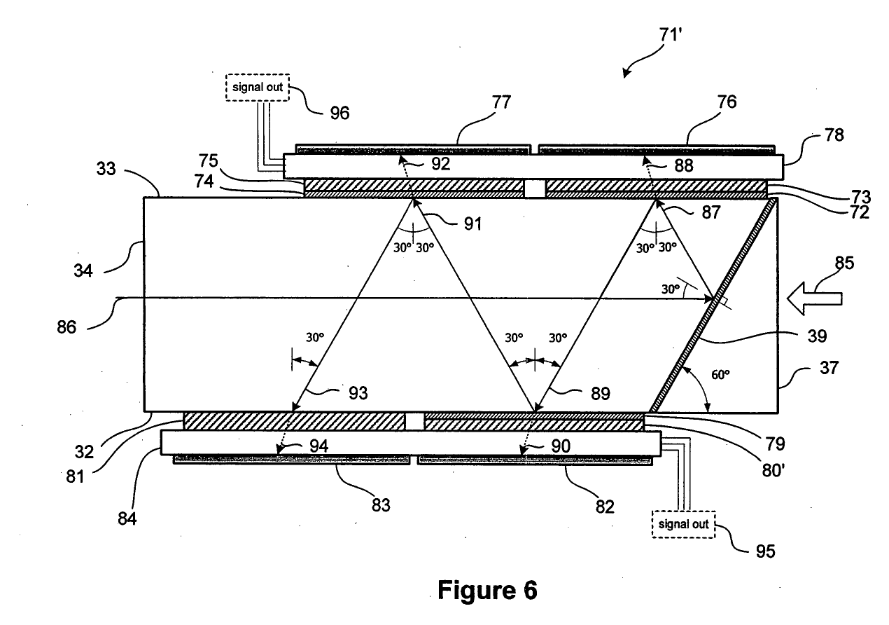

FIG. 6 shows a fourth preferred embodiment related to FIG. 5, but providing an additional pair of I/Q filters/detectors so that absolute measurement of the gap width may be determined as previously discussed. The additional pair includes an upstream one of the additional filters, indicated at 75, and a downstream one of the additional filters, indicated at 81. In order to reflect to the upstream additional filter, the original downstream filter 80′ now has a beam splitter 79 layered therebetween. Each of the additional upstream and downstream filters has a corresponding detector 77 and 83 affixed thereover. In particular, the detector 77 is mounted on the same substrate 78 as the original upstream detector 76, and the detector 83 is mounted on the same substrate 84 as the original downstream detector 82. Thus the optical path is increased by reflecting a portion of the second reflected beam 89 as a third reflected beam 91 to the upstream additional filter 75. A corresponding one of the I or Q components of the beam, indicated at 92, is passed through the filter 74 and detected at 77 where the detected signal is transmitted out at 96. A portion of the third reflected beam 91 is reflected from the beam splitter 72 as a fourth reflected beam 93 to the downstream additional filter 32, where a corresponding one of the I or Q components of the beam, indicated at 94 is passed through and detected at 83. The detected signals are transmitted to an analyzer as indicated at 95.

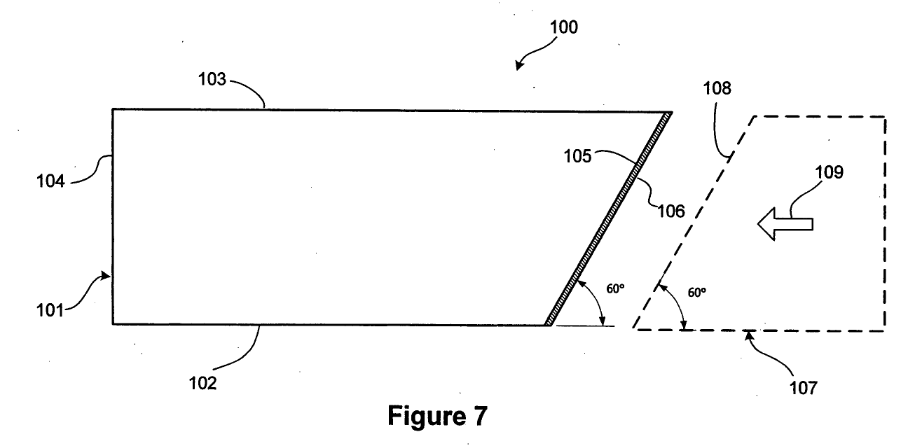

FIG. 7 shows another preferred embodiment of the present invention, generally indicated at reference character 100, where the prism comprises only a single optically transparent block 101 having an input facet 105 coated with a beam splitter 106, an output facet 104 at an opposite end of the prism, and top surface 103 and bottom surface 102. The beam-splitter coated input facet 105 is the point of entry for a collimated input beam. In this regard, this embodiment is configured for operation together with a collimator or other optic element, generally indicated at 107, have an angled facet 108 adapted to interface with the beam splitter coated input facet 105. The collimated input beam 109 is shown directed at the angled facet 108 at an incidence angle of about 60 degrees which comports to the operational parameters of the processor 100.

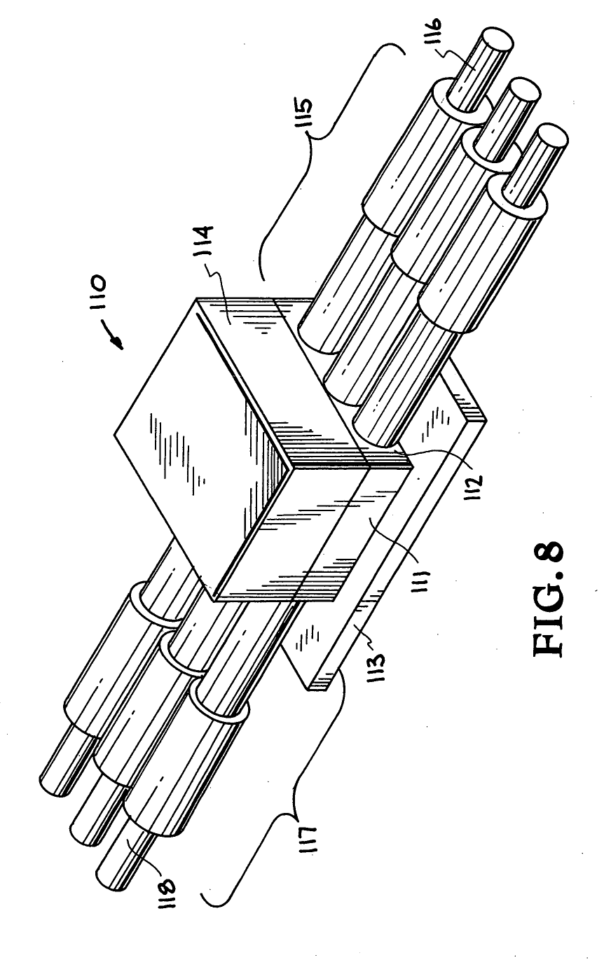

And FIG. 8 shows perspective view of a multi-channel embodiment of the present invention, generally indicated at reference character 110, and illustrating the manner of optically coupling to the multiple channels. The monolithic prism is shown having a first optically transparent block 112 and a second optically transparent block 111 joined at a beam splitter interface, and mounted on a base 113, such as may be used for packaging the processor 110. As shown, the prism is dimensioned to be sufficiently wide across the input facet 112, such that multiple channels (3 shown) may be optically coupled to enter the prism. In particular, fiber optics 116 carry light input into a collimator area, indicated at 115, prior to entering the prism. Additionally, a second collimator area 117 is shown on the opposite side of the processor for collimating the return-ranging encoded beam prior to re-entering the prism back from an external sensor, which is optically coupled via optic fiber 118. Thus, a multi-channel system is achieved by simply extending the dimension of the prism to produce additional side-by-side adjacent channels. Additional pairs of I/Q filters and detectors would also be provided to support each channel. Block 114 is placed over the prism representing the filters and detectors necessary to support such a multi-channel operation.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the appended claims.

1. An I/Q optical signal processor comprising:
a monolithic prism comprising an optically transparent block having a facet coated with a beam splitter (“beam splitter-coated facet”) for receiving a collimated input beam into the block, an output facet opposite the beam splitter-coated facet for exiting the collimated input beam out to an optical sensor and receiving a collimated encoded beam back from the optical sensor, and top and bottom surfaces extending between the beam splitter-coated facet and the output facet;
an in-phase filter (“I-filter”) affixed over one of the top and bottom surfaces;
a first detector affixed over the I-filter;
a quadrature filter (“Q-filter”) affixed over one of the top and bottom surfaces at a different area than the I-filter;
a second detector affixed over the Q-filter;
wherein the beam splitter-coated facet defines a plane angled to reflect a portion of the collimated encoded beam as a first reflected beam to one of the I/Q filters (“upstream filter”), so that a corresponding in-phase or quadrature component of the collimated encoded beam is passed through the upstream filter and detected by a corresponding one of the first and second detectors; and
means coated over at least one of the top and bottom surfaces for directing a portion of the first reflected beam to the other one of the I/Q filters (“downstream filter”), so that a corresponding in-phase or quadrature component of the collimated encoded beam is passed through the downstream filter and detected by a corresponding one of the first and second detectors.

2. The I/Q optical signal processor of claim 1,
wherein the monolithic prism further comprises a second optically transparent block joined to interface the first optically transparent block at the beam splitter-coated facet, said second optically transparent block having an input facet opposite the beam splitter-coated facet and orthogonal to the collimated input beam for receiving the collimated input beam therethrough.

3. The I/Q optical signal processor of claim 1,
wherein the first and second optically transparent blocks are made of fused silica glass.

4. The I/Q optical signal processor of claim 1,
wherein the monolithic prism, including the beam splitter-coated facet and the output facet, has a breadth capable of supporting a plurality of independent channels in parallel.

5. The I/Q optical signal processor of claim 1,
wherein the plane defined by the beam splitter-coated facet is angled to produce an angle of incidence of about 60 degrees with the collimated encoded beam.

6. The I/Q optical signal processor of claim 1,
wherein the beam splitter of the beam splitter-coated facet is a 50/50 splitter.

7. The I/Q optical signal processor of claim 1,
wherein the beam splitter of the beam splitter-coated facet is deposition-formed thereon.

8. The I/Q optical signal processor of claim 1,
wherein the means for directing a portion of the first reflected beam to the downstream filter comprises a second beam splitter layered between the upstream filter and the corresponding one of the top and bottom surfaces to reflect a portion of the first reflected beam as a second reflected beam.

9. The I/Q optical signal processor of claim 8,
wherein the second beam splitter is a 50/50 splitter.

10. The I/Q optical signal processor of claim 8,
wherein the second beam splitter is deposition-formed on the corresponding one of the top and bottom surfaces.

11. The I/Q optical signal processor of claim 8,
wherein the upstream filter is deposition-formed on the second beam splitter.

12. The I/Q optical signal processor of claim 8,
wherein the upstream filter comprises a layered construction having a filter layer formed on an optically transparent substrate, said layered construction bonded to the second beam splitter.

13. The I/Q optical signal processor of claim 8,
wherein the upstream filter is affixed over one of the top and bottom surfaces, and the downstream filter is affixed over the other one of the top and bottom surfaces and in the optic path of the second reflected beam for being incidenced thereby.

14. The I/Q optical signal processor of claim 8,
wherein the upstream and downstream filters are affixed over the same one of the top and bottom surfaces, and the means for directing a portion of the first reflected beam to the downstream filter further comprises: a mirror coated on the other one of the top and bottom surfaces opposite the I/Q filters, said mirror in the optic path of the second reflected beam to reflect a portion of the second reflected beam as a third reflected beam to the downstream filter.

15. The I/Q optical signal processor of claim 14,
wherein the mirror is deposition-formed on the corresponding one of the top and bottom surfaces.

16. The I/Q optical signal processor of claim 1,
wherein the downstream filter is deposition-formed on the corresponding one of the top and bottom surfaces.

17. The I/Q optical signal processor of claim 1,
wherein the downstream filter comprises a layered construction having a filter layer formed on an optically transparent substrate, said layered construction bonded to the corresponding one of the top and bottom surfaces.

18. The I/Q optical signal processor of claim 1,
wherein the first and second detectors are each flip-chip mounted on a optically transparent substrate.

19. The I/Q optical signal processor of claim 18,
wherein the first and second detectors are bonded to their respective filters via the optically transparent substrate.

20. The I/Q optical signal processor of claim 1, further comprising:
at least one additional pair of I/Q filters, each additional filter affixed over one of the top and bottom surfaces at a different area than the other filters;
at least one additional pair of detectors, each affixed over a corresponding one of the additional filters; and
means coated over at least one of the top and bottom surfaces for directing a portion of the first reflected beam to the additional pair(s) of I/Q filters, so that predetermined components of the collimated encoded light beam are passed through the additional filters and detected by the corresponding additional detectors.

21. An I/Q optical signal processor for use with a Fabry-Perot optic sensor comprising:
a monolithic prism comprising an optically transparent first block joined to an optically transparent second block at a beam splitter interface to form first and second ends on opposite sides of said beam splitter interface with top and bottom surfaces extending between the first and second ends, said first end having an input facet through which at least one collimated input beam may enter the prism, and said second end having an output facet through which the collimated input beam may exit out to a Fabry-Perot optical sensor and a collimated encoded beam from the Fabry-Perot optical sensor may re-enter the prism;
an in-phase filter (I-filter) affixed over one of the top and bottom surfaces on the same side of the beam splitter interface as the output facet;
a first detector affixed over the I-filter;
a quadrature filter (Q-filter) affixed over one of the top and bottom surfaces on the same side of the beam splitter interface as the output facet and at a different area than the I-filter;
a second detector affixed over the Q-filter;
wherein the beam splitter interface defines a plane angled to reflect a portion of the collimated encoded beam as a first reflected beam to one of the I/Q filters (upstream filter), so that a corresponding in-phase or quadrature component of the collimated encoded beam is passed through the upstream filter and detected by a corresponding one of the first and second detectors; and
means coated over at least one of the top and bottom surfaces for directing a portion of the first reflected beam to the other one of the I/Q filters (downstream filter), so that a corresponding in-phase or quadrature component of the collimated encoded beam is passed through the downstream filter and detected by a corresponding one of the first and second detectors.

22. The I/Q optical signal processor of claim 21,
wherein the monolithic prism, including the beam splitter-coated facet and the output facet, has a breadth capable of supporting a plurality of independent channels in parallel.

23. The I/Q optical signal processor of claim 21,
wherein the plane defined by the beam splitter interface is angled to produce an angle of incidence of about 60 degrees with the collimated encoded beam.

24. The I/Q optical signal processor of claim 21,
wherein the means for directing a portion of the first reflected beam to the downstream filter comprises a second beam splitter layered between the upstream filter and the corresponding one of the top and bottom surfaces to reflect a portion of the first reflected beam as a second reflected beam.

25. The I/Q optical signal processor of claim 24,
wherein the upstream filter is affixed over one of the top and bottom surfaces, and the downstream filter is affixed over the other one of the top and bottom surfaces and in the optic path of the second reflected beam for being incidenced thereby.

26. The I/Q optical signal processor of claim 24,
wherein the upstream and downstream filters are affixed over the same one of the top and bottom surfaces, and the means for directing a portion of the first reflected beam to the downstream filter further comprises: a mirror coated on the other one of the top and bottom surfaces opposite the I/Q filters, said mirror in the optic path of the second reflected beam to reflect a portion of the second reflected beam as a third reflected beam to the downstream filter.

27. The I/Q optical signal processor of claim 21, further comprising:
at least one additional pair of I/Q filters, each additional filter affixed over one of the top and bottom surfaces at a different area than the other filters;
at least one additional pair of detectors, each affixed over a corresponding one of the additional filters; and
means coated over at least one of the top and bottom surfaces for directing a portion of the first reflected beam to the additional pair(s) of I/Q filters, so that predetermined components of the collimated encoded light beam are passed through the additional filters and detected by the corresponding additional detectors.

28. A monolithic optical signal processor comprising:
a monolithic prism having a plurality of facets;
a first filter affixed over one of said facets;
a first detector affixed over the first filter;
a second filter affixed over one of said side facets at a different location from the first filter;
a second detector affixed over the second filter; and
facet-covering means for directing a collimated encoded light beam to both the first filter and the second filter from within the prism so that a first component of the collimated encoded light beam is passed through the first filter and detected by the first detector, and a second component of the collimated encoded light beam is passed through the second filter and detected by the second detector.

29. The monolithic optical signal processor of claim 28,
wherein the monolithic prism comprises a first optically transparent block joined to a second optically transparent block at a beam splitter interface, and the facet-covering means for directing a collimated encoded light beam to both the first filter and the second filter from within the prism includes:
the beam splitter interface defining a plane angled to reflect a portion of the collimated encoded light beam as a first reflected beam to the first filter; and
facet-covering means for directing a portion of the first reflected beam to the second filter.

30. The monolithic optical signal processor of claim 28,
wherein the facet-covering means for directing a collimated encoded light beam to both the first filter and the second filter from within the prism comprises:
a first beam splitter coated on a first facet defining a plane angled to reflect a portion of the collimated encoded light beam as a first reflected beam to the first filter; and
facet-covering means for directing a portion of the first reflected beam to the second filter.

31. The monolithic optical signal processor of claim 30,
wherein the first filter and the second filter are affixed on opposite sides of the prism, and
wherein the facet-covering means for directing a portion of the first reflected beam to the second filter comprises a second beam splitter layered between the first filter and its associated facet to reflect a portion of the first reflected beam as a second reflected beam to the second filter.

32. The monolithic optical signal processor of claim 30,
wherein the first filter and the second filter are affixed on the same side of the prism, and
wherein the facet-covering means for directing a portion of the first reflected beam to the second filter comprises:
a second beam splitter layered between the first filter and its associated facet to reflect a portion of the first reflected beam as a second reflected beam; and
a mirror coated on a facet located on an opposite side of the prism as the filters with said mirror in line with the second reflected beam to reflect the second reflected beam as a third reflected beam to the second filter.

33. The monolithic optical signal processor of claim 30, further comprising:
at least one additional pair of filters, each additional filter affixed over one of the top and bottom surfaces at a different area than the other filters;
at least one additional pair of detectors, each affixed over a corresponding one of the additional filters; and
facet-covering means for directing the collimated encoded light beam to the additional pair(s) of filters, so that predetermined components of the collimated encoded light beam are passed through the additional filters and detected by the corresponding additional detectors.
